(19) United States
(12) Patent Application Publication
(10) Pub. No.: US 2009/0073448 A1
(43) Pub. Date: Mar. 19, 2009

(54) Method of measuring the overlay error, an inspection apparatus and a lithographic apparatus

(75) Inventors: Manfred Gawein Tenner, Eindhoven (NL); Maurits Van Der Schaar, Eindhoven (NL)

Correspondence Address: STERNE, KESSLER, GOLDSTEIN & FOX P.L.L.C., 1100 NEW YORK AVENUE, N.W., WASHINGTON, DC, 20005, US

(73) Assignee: ASML Netherlands B.V., Veldhoven (NL)

(21) Appl. No.: 11/902,061

(22) Filed: Sep. 18, 2007

(51) Int. Cl. G01N 21/47

(52) U.S. Cl. 356/446

(57) ABSTRACT

The reflected radiation from a target mark including, for example, a plurality of gratings is detected by an array of pixels. The overlay error of the gratings for each pixel is detected, and an array of overlay errors is determined. Rather than simply averaging the overlay error value for all the pixels, filtering is performed. Pixels may be filtered according to the detected value of the overlay error or the detected intensity of the pixel.

### FIELD

The present invention relates to methods of inspection usable, for example, in the manufacture of devices by lithographic techniques and to methods of manufacturing devices using lithographic techniques.

### BACKGROUND

A lithographic apparatus is a machine that applies a desired pattern onto a substrate, usually onto a target portion of the substrate. A lithographic apparatus can be used, for example, in the manufacture of integrated circuits (ICs). In that instance, a patterning device, which is alternatively referred to as a mask or a reticle, may be used to generate a circuit pattern to be formed on an individual layer of the IC. This pattern can be transferred onto a target portion (e.g. including part of, one, or several dies) on a substrate (e.g. a silicon wafer). Transfer of the pattern is typically via imaging onto a layer of radiation-sensitive material (resist) provided on the substrate. In general, a single substrate will contain a network of adjacent target portions that are successively patterned. Known lithographic apparatus include so-called steppers, in which each target portion is irradiated by exposing an entire pattern onto the target portion at one time, and so-called scanners, in which each target portion is irradiated by scanning the pattern through a radiation beam in a given direction (the “scanning”-direction) while synchronously scanning the substrate parallel or anti-parallel to this direction. It is also possible to transfer the pattern from the patterning device to the substrate by imprinting the pattern onto the substrate.

In order to monitor the lithographic process, it is desirable to measure parameters of the patterned substrate, for example, the overlay error between successive layers formed in or on it. There are various techniques for making measurements of the microscopic structures formed in lithographic processes, including the use of scanning electron microscopes and various specialized tools. One form of specialized inspection tool is a scatterometer in which a beam of radiation is directed onto a target on the surface of the substrate and properties of the scattered or reflected beam are measured. By comparing the properties of the beam before and after it has been reflected or scattered by the substrate, the properties of the substrate can be determined. This can be done, for example, by comparing the reflected beam with data stored in a library of known measurements associated with known substrate properties. Two main types of scatterometer are known. Spectroscopic scatterometers direct a broadband radiation beam onto the substrate and measure the spectrum (intensity as a function of wavelength) of the radiation scattered into a particular narrow angular range. Angularly resolved scatterometers use a monochromatic radiation beam and measure the intensity of the scattered radiation as a function of angle.

Such a system of illuminating a target and collecting data from the reflected radiation is often used to calculate the overlay error, OV for a pattern. Generally this is achieved by forming a plurality of superimposed gratings (forming a target) into the substrate and measuring the reflected radiation. The gratings may be formed by etching into the substrate or by forming the grating in developed resist. Often the lower layers of gratings are etched into the substrate and the uppermost grating is formed in developed resist. The reflected radiation is detected on a plurality of pixels and the average overlay error for each pixel is calculated. The average overlay error for the complete target is then calculated by averaging the overlay error of all the pixels for a specific target.

However, the method of averaging the overlay error for all the pixels for a given target may be subject to significant noise and random errors. This may lead to an overestimation of the final calculated overlay error, and tests indicate that this overestimation may be as much as 40%.

### SUMMARY

It is desirable to provide an alternative method of calculating the overlay error which reduces the effect of noise and results in a more accurate overlay error calculation.

According to an aspect of the invention, there is provided a method of measuring the overlay error for a mark including a repeating pattern of known period, P, the method including projecting a beam of radiation onto a target mark; measuring the reflected radiation from the mark on a plurality of pixels using a scatterometer to determine the overlay error per pixel; excluding the pixels with an overlay error larger than a threshold value; and averaging the overlay error of the pixels not excluded to determine the average overlay error.

According to a further aspect of the invention there is provided a method of measuring the overlay error for a mark including projecting a beam of radiation onto a target mark; measuring the reflected radiation from the mark on a plurality of pixels using a scatterometer to determine the overlay error per pixel; calculating the initial average overlay error and the standard deviation of the overlay error; excluding the pixels having an overlay error outside a defined range of the initial average overlay error; and averaging the overlay error of the pixels not excluded to determine the average overlay error.

According to a further aspect of the invention there is provided a method of measuring the overlay error for a mark including projecting a beam of radiation onto a target mark; measuring the reflected radiation from the mark on a plurality of pixels using a scatterometer to determine the overlay error per pixel; excluding the pixels having an intensity below a threshold value; and averaging the overlay error of the pixels not excluded to determine the average overlay error.

According to an aspect of the invention, there is provided an inspection apparatus configured to measure a property of a substrate, the apparatus including a radiation source configured to direct a radiation on a substrate; a detector configured to detect the radiation reflected from the substrate on a plurality of pixels; and a data handling unit configured to exclude the pixels having an overlay error larger than a threshold value and average the overlay error of the pixels not excluded to determine the average overlay error.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1a depicts a lithographic apparatus in accordance with an embodiment of the invention;

FIG. 1b depicts a lithographic cell or cluster in accordance with an embodiment of the invention;

FIG. 2 depicts a first scatterometer according to an embodiment of the invention;

FIG. 3 depicts a second scatterometer according to an embodiment of the invention;

FIG. 4a depicts a target;

FIG. 4b depicts an array of pixels for detecting the reflected radiation;

FIG. 5 depicts a graph showing the pixels according to an embodiment of the invention;

FIG. 6 depicts a graph showing the pixels according to an embodiment of the invention;

FIG. 7 depicts a graph showing the pixels according to an embodiment of the invention; and

FIG. 8 depicts a graph of the average overlay measurement calculated according to an embodiment of the invention compared to the average overlay measurement calculated using a conventional technique.

### DETAILED DESCRIPTION

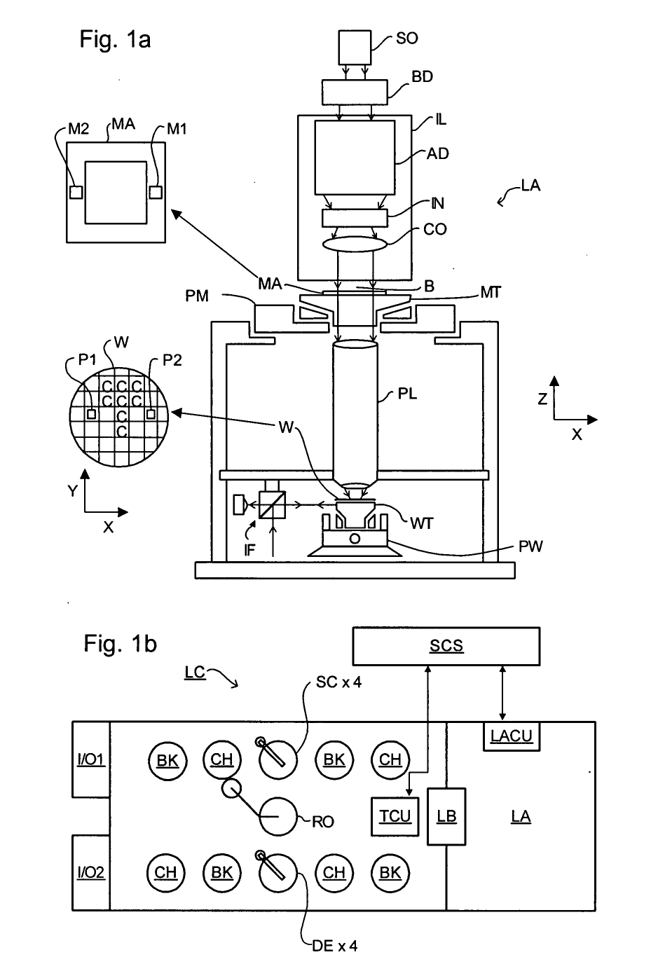

FIG. 1 a schematically depicts a lithographic apparatus. The apparatus includes an illumination system (illuminator) IL configured to condition a radiation beam B (e.g. UV radiation or DUV radiation); a support structure (e.g. a mask table) MT constructed to support a patterning device (e.g. a mask) MA and connected to a first positioner PM configured to accurately position the patterning device in accordance with certain parameters; a substrate table (e.g. a wafer table) WT constructed to hold a substrate (e.g. a resist-coated wafer) W and connected to a second positioner PW configured to accurately position the substrate in accordance with certain parameters; and a projection system (e.g. a refractive projection lens system) PL configured to project a pattern imparted to the radiation beam B by patterning device MA onto a target portion C (e.g. including one or more dies) of the substrate W.

The illumination system may include various types of optical components, such as refractive, reflective, magnetic, electromagnetic, electrostatic or other types of optical components, or any combination thereof, for directing, shaping, or controlling radiation.

The support structure holds the patterning device in a manner that depends on the orientation of the patterning device, the design of the lithographic apparatus, and other conditions, such as for example whether or not the patterning device is held in a vacuum environment. The support structure can use mechanical, vacuum, electrostatic or other clamping techniques to hold the patterning device. The support structure may be a frame or a table, for example, which may be fixed or movable as required. The support structure may ensure that the patterning device is at a desired position, for example with respect to the projection system. Any use of the terms “reticle” or “mask” herein may be considered synonymous with the more general term “patterning device.”

The term “patterning device” used herein should be broadly interpreted as referring to any device that can be used to impart a radiation beam with a pattern in its cross-section such as to create a pattern in a target portion of the substrate. It should be noted that the pattern imparted to the radiation beam may not exactly correspond to the desired pattern in the target portion of the substrate, for example if the pattern includes phase-shifting features or so called assist features. Generally, the pattern imparted to the radiation beam will correspond to a particular functional layer in a device being created in the target portion, such as an integrated circuit.

The patterning device may be transmissive or reflective. Examples of patterning devices include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions. The tilted mirrors impart a pattern in a radiation beam, which is reflected by the mirror matrix.

The term “projection system” used herein should be broadly interpreted as encompassing any type of projection system, including refractive, reflective, catadioptric, magnetic, electromagnetic and electrostatic optical systems, or any combination thereof, as appropriate for the exposure radiation being used, or for other factors such as the use of an immersion liquid or the use of a vacuum. Any use of the term “projection lens” herein may be considered as synonymous with the more general term “projection system”.

As here depicted, the apparatus is of a transmissive type (e.g. employing a transmissive mask). Alternatively, the apparatus may be of a reflective type (e.g. employing a programmable mirror array of a type as referred to above, or employing a reflective mask).

The lithographic apparatus may be of a type having two (dual stage) or more substrate tables (and/or two or more mask tables). In such “multiple stage” machines the additional tables may be used in parallel, or preparatory steps may be carried out on one or more tables while one or more other tables are being used for exposure.

The lithographic apparatus may also be of a type wherein at least a portion of the substrate may be covered by a liquid having a relatively high refractive index, e.g. water, so as to fill a space between the projection system and the substrate. An immersion liquid may also be applied to other spaces in the lithographic apparatus, for example, between the mask and the projection system. Immersion techniques are well known in the art for increasing the numerical aperture of projection systems. The term “immersion” as used herein does not mean that a structure, such as a substrate, must be submerged in liquid, but rather only means that liquid is located between the projection system and the substrate during exposure.

Referring to FIG. 1a, the illuminator IL receives a radiation beam from a radiation source SO. The source and the lithographic apparatus may be separate entities, for example when the source is an excimer laser. In such cases, the source is not considered to form part of the lithographic apparatus and the radiation beam is passed from the source SO to the illuminator IL with the aid of a beam delivery system BD including, for example, suitable directing mirrors and/or a beam expander. In other cases the source may be an integral part of the lithographic apparatus, for example when the source is a mercury lamp. The source SO and the illuminator IL, together with the beam delivery system BD if required, may be referred to as a radiation system.

The illuminator IL may include an adjuster AD for adjusting the angular intensity distribution of the radiation beam. Generally, at least the outer and/or inner radial extent (commonly referred to as σ-outer and σ-inner, respectively) of the intensity distribution in a pupil plane of the illuminator can be adjusted. In addition, the illuminator IL may include various other components, such as an integrator IN and a condenser CO. The illuminator may be used to condition the radiation beam, to have a desired uniformity and intensity distribution in its cross-section.

The radiation beam B is incident on the patterning device (e.g., mask) MA, which is held on the support structure (e.g., mask table) MT, and is patterned by the patterning device. Having traversed the patterning device (e.g. mask) MA, the radiation beam B passes through the projection system PL, which focuses the beam onto a target portion C of the substrate W. With the aid of the second positioner PW and position sensor IF (e.g. an interferometric device, linear encoder, 2-D encoder or capacitive sensor), the substrate table WT can be moved accurately, e.g. so as to position different target portions C in the path of the radiation beam B. Similarly, the first positioner PM and another position sensor (which is not explicitly depicted in FIG. 1a) can be used to accurately position the patterning device (e.g. mask) MA with respect to the path of the radiation beam B, e.g. after mechanical retrieval from a mask library, or during a scan. In general, movement of the support structure (e.g. mask table) MT may be realized with the aid of a long-stroke module (coarse positioning) and a short-stroke module (fine positioning), which form part of the first positioner PM. Similarly, movement of the substrate table WT may be realized using a long-stroke module and a short-stroke module, which form part of the second positioner PW. In the case of a stepper (as opposed to a scanner) the support structure (e.g. mask table) MT may be connected to a short-stroke actuator only, or may be fixed. Patterning device (e.g. mask) MA and substrate W may be aligned using mask alignment marks M1, M2 and substrate alignment marks P1, P2. Although the substrate alignment marks as illustrated occupy dedicated target portions, they may be located in spaces between target portions (these are known as scribe-lane alignment marks). Similarly, in situations in which more than one die is provided on the mask MA, the mask alignment marks may be located between the dies.

The depicted apparatus could be used in at least one of the following modes:

1. In step mode, the support structure (e.g. mask table) MT and the substrate table WT are kept essentially stationary, while an entire pattern imparted to the radiation beam is projected onto a target portion C at one time (i.e. a single static exposure). The substrate table WT is then shifted in the X and/or Y direction so that a different target portion C can be exposed. In step mode, the maximum size of the exposure field limits the size of the target portion C imaged in a single static exposure.

2. In scan mode, the support structure (e.g. mask table) MT and the substrate table WT are scanned synchronously while a pattern imparted to the radiation beam is projected onto a target portion C (i.e. a single dynamic exposure). The velocity and direction of the substrate table WT relative to the support structure (e.g. mask table) MT may be determined by the (de-)magnification and image reversal characteristics of the projection system PL. In scan mode, the maximum size of the exposure field limits the width (in the non-scanning direction) of the target portion in a single dynamic exposure, whereas the length of the scanning motion determines the height (in the scanning direction) of the target portion.

3. In another mode, the support structure (e.g. mask table) MT is kept essentially stationary holding a programmable patterning device, and the substrate table WT is moved or scanned while a pattern imparted to the radiation beam is projected onto a target portion C. In this mode, generally a pulsed radiation source is employed and the programmable patterning device is updated as required after each movement of the substrate table WT or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may also be employed.

As shown in FIG. 1b, the lithographic apparatus LA forms part of a lithographic cell LC, also sometimes referred to a lithocell or cluster, which also includes apparatus to perform pre- and post-exposure processes on a substrate. Conventionally these include spin coaters SC to deposit resist layers, developers DE to develop exposed resist, chill plates CH and bake plates BK. A substrate handler, or robot, RO picks up substrates from input/output ports I/O1, I/O2, moves them between the different process apparatus and delivers then to the loading bay LB of the lithographic apparatus. These devices, which are often collectively referred to as the track, are under the control of a track control unit TCU which is itself controlled by the supervisory control system SCS, which also controls the lithographic apparatus via lithography control unit LACU. Thus, the different apparatus can be operated to maximize throughput and processing efficiency.

In order that the substrates that are exposed by the lithographic apparatus are exposed correctly and consistently, it is desirable to inspect exposed substrates to measure properties such as overlay errors between subsequent layers, line thicknesses, critical dimensions (CD), etc. If errors are detected, adjustments may be made to exposures of subsequent substrates, especially if the inspection can be done soon and fast enough that other substrates of the same batch are still to be exposed. Also, already exposed substrates may be stripped and reworked—to improve yield—or discarded—thereby avoiding performing exposures on substrates that are known to be faulty. In a case where only some target portions of a substrate are faulty, further exposures can be performed only on those target portions which are good.

An inspection apparatus is used to determine the properties of the substrates, and in particular, how the properties of different substrates or different layers of the same substrate vary from layer to layer. The inspection apparatus may be integrated into the lithographic apparatus LA or the lithocell LC or may be a stand-alone device. To enable most rapid measurements, it is desirable that the inspection apparatus measure properties in the exposed resist layer immediately after the exposure. However, the latent image in the resist has a very low contrast—there is only a very small difference in refractive index between the parts of the resist which have been exposed to radiation and those which have not—and not all inspection apparatus have sufficient sensitivity to make useful measurements of the latent image. Therefore measurements may be taken after the post-exposure bake step (PEB) which is customarily the first step carried out on exposed substrates and increases the contrast between exposed and unexposed parts of the resist. At this stage, the image in the resist may be referred to as semi-latent. It is also possible to make measurements of the developed resist image—at which point either the exposed or unexposed parts of the resist have been removed—or after a pattern transfer step such as etching. The latter possibility limits the possibilities for rework of faulty substrates but may still provide useful information.

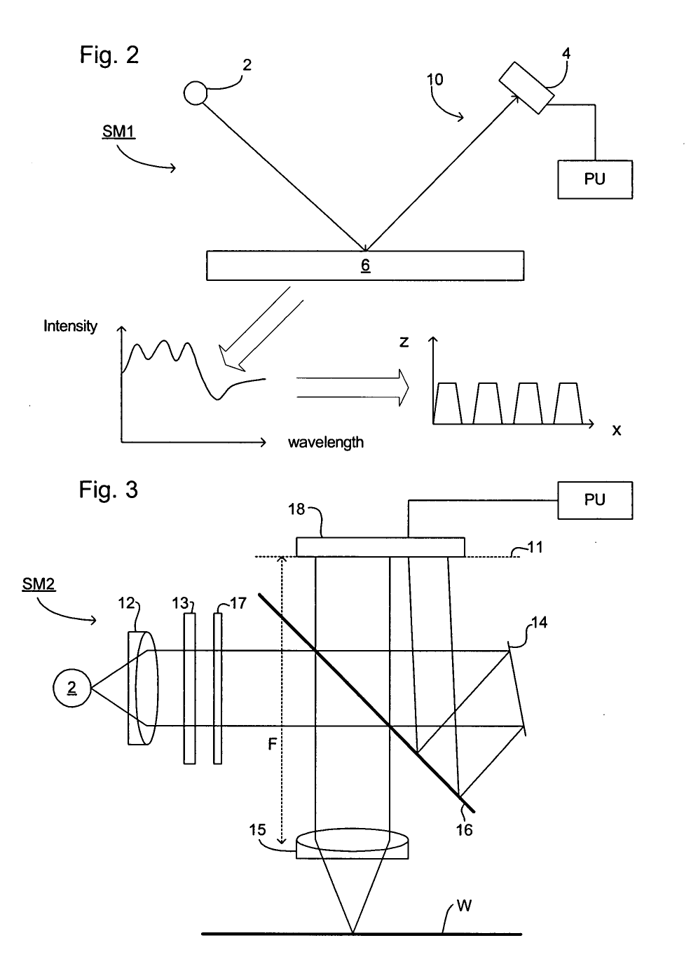

FIG. 2 depicts a scatterometer which may be used in the present invention. It includes a broadband (white light) radiation projector 2 configured to project radiation onto a substrate W. The radiation projector 2 may include a radiation source and at least one optical element to project the radiation onto the substrate. The radiation source and the at least one optical element may be integrated into a single unit or separate. The reflected radiation is passed to a spectrometer detector 4, which measures a spectrum 10 (intensity as a function of wavelength) of the specular reflected radiation. From this data, the structure or profile giving rise to the detected spectrum may be reconstructed by processing unit PU, e.g. by Rigorous Coupled Wave Analysis and non-linear regression or by comparison with a library of simulated spectra as shown at the bottom of FIG. 2. In general, for the reconstruction the general form of the structure is known and some parameters are assumed from knowledge of the process by which the structure was made, leaving only a few parameters of the structure to be determined from the scatterometry data. Such a scatterometer may be configured as a normal-incidence scatterometer or an oblique-incidence scatterometer.

Another scatterometer that may be used in an embodiment of the present invention is shown in FIG. 3. In this device, the radiation emitted by radiation source 2 is focused using lens system 12 through interference filter 13 and polarizer 17, reflected by partially reflected surface 16 and is focused onto substrate W via a microscope objective lens 15, which has a high numerical aperture (NA), preferably at least 0.9 and more preferably at least 0.95. Immersion scatterometers may even have lenses with numerical apertures over 1. The reflected radiation then transmits through partially reflective surface 16 into a detector 18 in order to have the scatter spectrum detected. The detector may be located in the back-projected pupil plane 11, which is at the focal length of the lens system 15, however the pupil plane may instead be re-imaged with auxiliary optics (not shown) onto the detector. The pupil plane is the plane in which the radial position of radiation defines the angle of incidence and the angular position defines azimuth angle of the radiation. The detector is preferably a two-dimensional detector so that a two-dimensional angular scatter spectrum of the substrate target can be measured. The detector 18 may be, for example, an array of CCD or CMOS sensors, and may use an integration time of, for example, 40 milliseconds per frame.

A reference beam is often used for example to measure the intensity of the incident radiation. To do this, when the radiation beam is incident on the beam splitter 16 part of it is transmitted through the beam splitter as a reference beam towards a reference mirror 14. The reference beam is then projected onto a different part of the same detector 18.

A set of interference filters 13 is available to select a wavelength of interest in the range of, say, 405-790 nm or even lower, such as 200-300 nm. The interference filter may be tunable rather than including a set of different filters. A grating could be used instead of interference filters.

The detector 18 may measure the intensity of scattered light at a single wavelength (or narrow wavelength range), the intensity separately at multiple wavelengths or integrated over a wavelength range. Furthermore, the detector may separately measure the intensity of transverse magnetic- and transverse electric-polarized light and/or the phase difference between the transverse magnetic- and transverse electric-polarized light.

Using a broadband light source (i.e. one with a wide range of light frequencies or wavelengths—and therefore of colors) is possible, which gives a large etendue, allowing the mixing of multiple wavelengths. The plurality of wavelengths in the broadband preferably each has a bandwidth of δλ and a spacing of at least 2 δλ (i.e. twice the bandwidth). Several “sources” of radiation can be different portions of an extended radiation source which have been split using fiber bundles. In this way, angle resolved scatter spectra can be measured at multiple wavelengths in parallel. A 3-D spectrum (wavelength and two different angles) can be measured, which contains more information than a 2-D spectrum. This allows more information to be measured which increases metrology process robustness. This is described in more detail in EP1,628,164A.

The target on substrate W may be a grating, which is printed such that after development, the bars are formed of solid resist lines. The bars may alternatively be etched into the substrate. This pattern is sensitive to chromatic aberrations in the lithographic projection apparatus, particularly the projection system PL, and illumination symmetry and the presence of such aberrations may manifest themselves in a variation in the printed grating. Accordingly, the scatterometry data of the printed gratings is used to reconstruct the gratings. The parameters of the grating, such as line widths and shapes, may be input to the reconstruction process, performed by processing unit PU, from knowledge of the printing step and/or other scatterometry processes.

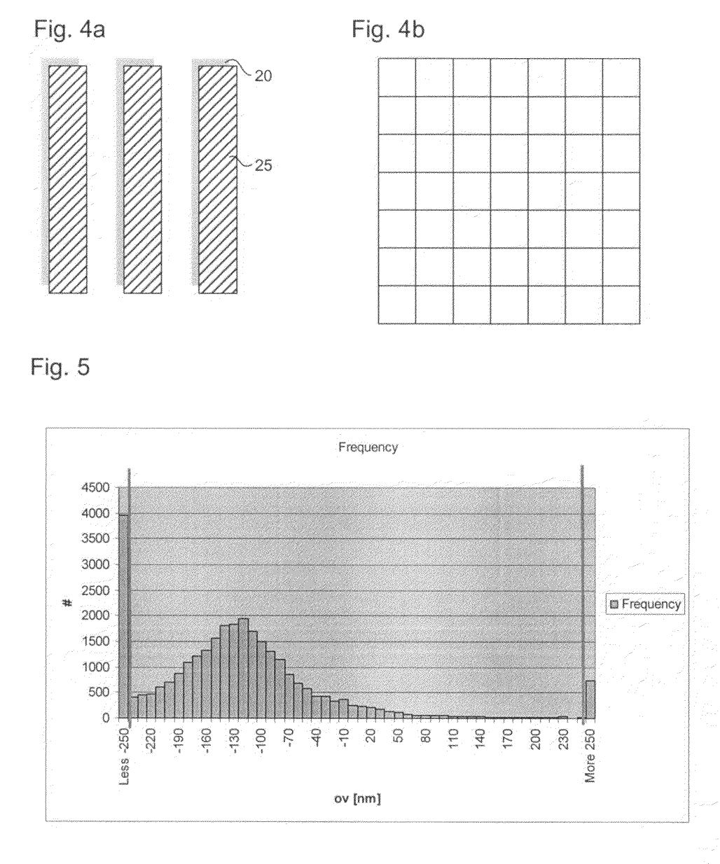

As shown in FIG. 4a the substrate W may include a plurality of patterns 20, 25 forming a target mark. The patterns may be printed such that after development, the bars are formed of solid resist lines or may be etched into the substrate using lithographic apparatus. Once the radiation is projected onto the substrate it is reflected back and the reflected radiation is detected using an array of pixels as shown in FIG. 4b. Many pixels will detect the radiation reflected from each target. Although only 25 pixels are depicted here many more pixels may be used.

Using the reflected radiation that has been detected, the overlay error for each pixel can been detected using commonly known technique. As an example a target mark may have a pitch of 500 nm. The spread of overlay errors detected in a plurality of pixels for such a target is shown in FIG. 5. As can be seen, there is a considerable variation of overlay errors. According to an embodiment of the invention, pixels having an overlay error of more than 50% of the grating pitch of the target mark are excluded. In this example, as shown in FIG. 5, pixels having an overlay error of greater than 250 nm are excluded. An average overlay of the overlay of all the remaining pixels is then calculated to give an average overlay error.

Although this example shows the pixels having an overlay error of more than 50% of the grating pitch being excluded, it could be any predetermined value, either as a proportion of the grating pitch, another feature of the target mark or as an absolute value.

It should be appreciated that the value or range of the overlay error may be a threshold value that can be predetermined, or can be a threshold value that is determined “on the fly” based on factors or parameters that may be measured on a case by case basis.

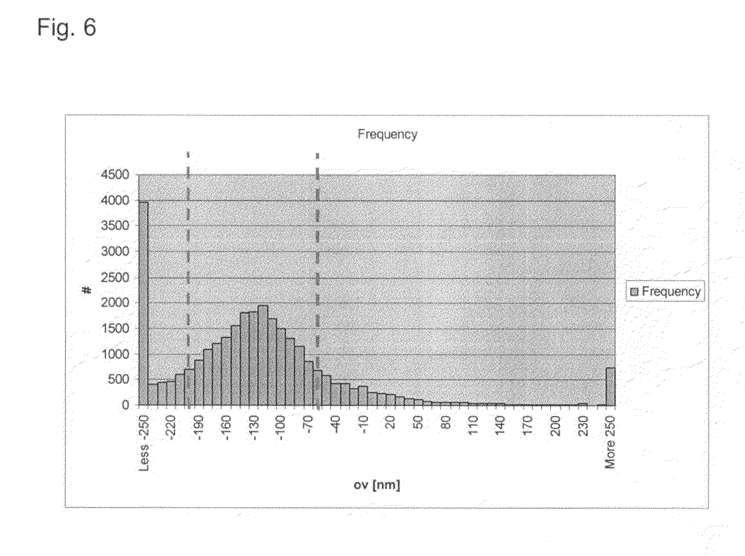

An embodiment of the invention uses the same array of overlay errors. However, this time the characteristics of the overlay error distribution are used to exclude pixels. For example, FIG. 6 shows the pixels having an overlay value greater than two standard deviations away from the (initial) average overlay error being excluded. In this embodiment the initial average overlay error, together with the standard deviation are calculated. The pixels having an overlay error greater than, for example 2 standard deviations away from the (initial) average overlay error are then excluded, before the overlay error of all the remaining pixels is calculated to give an average overlay error.

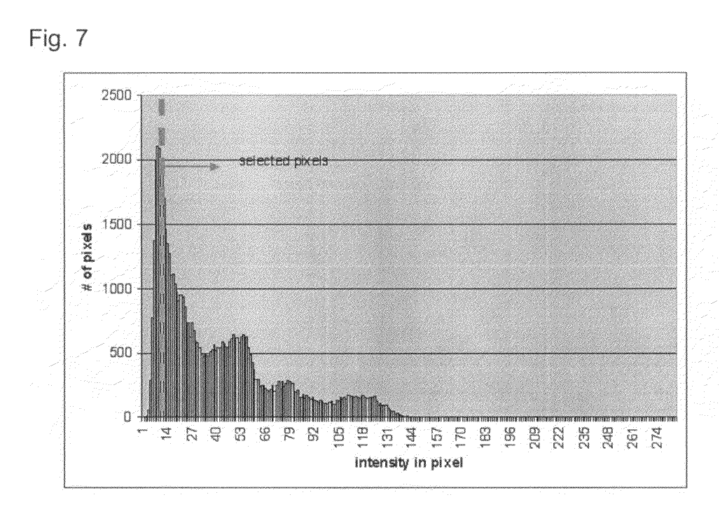

In another embodiment of the invention, the intensity of the pixels is used. This may be useful because, for example, pixels subject to noise or other random errors may give a reduced reading. An example distribution of intensities of pixels is shown in FIG. 7. In this example the pixels having an intensity lower than a specific value are excluded before an average of the remaining pixels is taken. However, it could be that a proportion of the pixels having the lowest intensity are excluded or a feature of the distribution of intensities, for example only those within a given number of standard deviations of the mean.

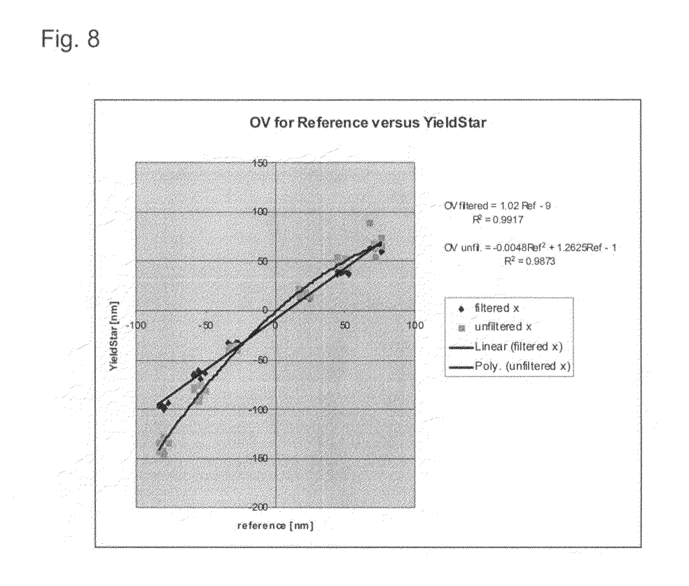

FIG. 8 depicts a graph showing the calculated values for the overlay error against the actual overlay errors for an array of overlay errors using both the conventional averaging technique and using a technique according to one of the embodiments of the invention. As can be seen, a much more linear relationship is shown between the calculated and actual overlay errors when the filtering technique according to one of the embodiments of the invention is used.

Although three separate embodiments of the invention have been described, two or three of the methods could easily be combined. For example pixels having an overlay error greater than two standard deviations from the (initial) average and pixels having an intensity lower than a predetermined value could be excluded.

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, flat-panel displays, liquid-crystal displays (LCDs), thin film magnetic heads, etc. The skilled artisan will appreciate that, in the context of such alternative applications, any use of the terms “wafer” or “die” herein may be considered as synonymous with the more general terms “substrate” or “target portion”, respectively. The substrate referred to herein may be processed, before or after exposure, in for example a track (a tool that typically applies a layer of resist to a substrate and develops the exposed resist), a metrology tool and/or an inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

Although specific reference may have been made above to the use of embodiments of the invention in the context of optical lithography, it will be appreciated that the invention may be used in other applications, for example imprint lithography, and where the context allows, is not limited to optical lithography. In imprint lithography a topography in a patterning device defines the pattern created on a substrate. The topography of the patterning device may be pressed into a layer of resist supplied to the substrate whereupon the resist is cured by applying electromagnetic radiation, heat, pressure or a combination thereof. The patterning device is moved out of the resist leaving a pattern in it after the resist is cured.

The terms “radiation” and “beam” used herein encompass all types of electromagnetic radiation, including ultraviolet (UV) radiation (e.g. having a wavelength of or about 365, 355, 248, 193, 157 or 126 nm) and extreme ultra-violet (EUV) radiation (e.g. having a wavelength in the range of 5-20 nm), as well as particle beams, such as ion beams or electron beams.

The term “lens”, where the context allows, may refer to any one or combination of various types of optical components, including refractive, reflective, magnetic, electromagnetic and electrostatic optical components.

While specific embodiments of the invention have been described above, it will be appreciated that the invention may be practiced otherwise than as described. For example, the invention may take the form of a computer program containing one or more sequences of machine-readable instructions describing a method as disclosed above, or a data storage medium (e.g. semiconductor memory, magnetic or optical disk) having such a computer program stored therein.

The descriptions above are intended to be illustrative, not limiting. Thus, it will be apparent to one skilled in the art that modifications may be made to the invention as described without departing from the scope of the claims set out below.

1. A method of measuring an overlay error of a mark comprising a repeating pattern of period, P, the method comprising:
projecting a beam of radiation onto the mark;
measuring the reflected radiation from the mark on a plurality of pixels using a scatterometer to determine the overlay error per pixel;
excluding the pixels with an overlay error larger than a threshold value; and
averaging the overlay error of the pixels not excluded to determine an average overlay error.

2. A method according to claim 1, wherein the threshold value is a proportion of the period P.

3. A method according to claim 2, wherein the proportion is 50% of the period P.

4. An inspection apparatus configured to measure a property of a substrate, the apparatus comprising:
a radiation projector configured to project radiation onto a substrate;
a detector configured to detect the radiation reflected from the substrate on a plurality of pixels; and
a data handling unit configured to exclude the pixels having an overlay error larger than a threshold value and average the overlay error of the pixels not excluded to determine an average overlay error.

5. A lithographic apparatus comprising:
an illumination support configured to condition a radiation beam;
a support constructed to support a patterning device, the patterning device being capable of imparting the radiation beam with a pattern in its cross-section to form a patterned radiation beam;
a substrate table constructed to hold a substrate;
a projection system configured to project the patterned radiation beam onto a target portion of the substrate; and
an inspection apparatus configured to measure a property of the substrate, the inspection apparatus comprising:
a radiation projector configured to project radiation onto a substrate;
a detector configured to detect the radiation reflected from the substrate on a plurality of pixels; and
a data handling unit configured to exclude the pixels having an overlay error larger than a threshold value and average the overlay error of the pixels not excluded to determine the average overlay error

6. A method of measuring the overlay error of a mark comprising:
projecting a beam of radiation onto the mark;
measuring the reflected radiation from the mark on a plurality of pixels using a scatterometer to determine the overlay error per pixel;
calculating the initial average overlay error and the standard deviation of the overlay error;
excluding the pixels having an overlay error outside a threshold range of the initial average overlay error; and
averaging the overlay error of the pixels not excluded to determine an average overlay error.

7. A method according to claim 6, wherein the threshold range is a threshold number of standard deviations from the initial overlay error.

8. A method according to claim 7, wherein the range is within 2 standard deviations of the initial overlay error.

9. An inspection apparatus configured to measure a property of a substrate, the inspection apparatus comprising:
a radiation projector configured to project radiation onto a substrate;
a detector configured to detect the radiation reflected from the substrate on a plurality of pixels; and
a data handling unit configured to calculate an initial average overlay error, exclude the pixels having an overlay error outside a threshold range of the initial average overlay error and average the overlay error of the pixels not excluded to determine an average overlay error.

10. A lithographic apparatus comprising:
an illumination support configured to condition a radiation beam;
a support constructed to support a patterning device, the patterning device being capable of imparting the radiation beam with a pattern in its cross-section to form a patterned radiation beam;
a substrate table constructed to hold a substrate;
a projection system configured to project the patterned radiation beam onto a target portion of the substrate; and
an inspection apparatus configured to measure a property of a substrate, the inspection apparatus comprising:
a radiation projector configured to project radiation onto the substrate;
a detector configured to detect the radiation reflected from the substrate on a plurality of pixels; and
a data handling unit configured to calculate an initial average overlay error, exclude the pixels having an overlay error outside a threshold range of the initial average overlay error and average the overlay error of the pixels not excluded to determine an average overlay error.

11. A method of measuring the overlay error of a mark comprising:
projecting a beam of radiation onto the mark;
measuring the reflected radiation from the mark on a plurality of pixels using a scatterometer to determine the overlay error per pixel;
excluding the pixels having an intensity below a threshold value; and
averaging the overlay error of the pixels not excluded to determine the average overlay error.

12. An inspection apparatus configured to measure a property of a substrate, the inspection apparatus comprising:
a radiation projector configured to project radiation onto a substrate;
a detector configured to detect the radiation reflected from the substrate on a plurality of pixels; and
a data handling unit configured to exclude the pixels having an intensity below a threshold value and average the overlay error of the pixels not excluded to determine an average overlay error.

13. A lithographic apparatus comprising:
an illumination support configured to condition a radiation beam;
a support constructed to support a patterning device, the patterning device being capable of imparting the radiation beam with a pattern in its cross-section to form a patterned radiation beam;
a substrate table constructed to hold a substrate;
a projection system configured to project the patterned radiation beam onto a target portion of the substrate; and
an inspection apparatus according configured to measure a property of the substrate, the inspection apparatus comprising:
a radiation projector configured to project radiation onto a substrate;
a detector configured to detect the radiation reflected from the substrate on a plurality of pixels; and
a data handling unit configured to exclude the pixels having an intensity below a threshold value and average the overlay error of the pixels not excluded to determine the average overlay error.

14. An inspection apparatus configured to measure a property of a substrate, the apparatus comprising:
a radiation source configured to direct a radiation on a substrate;
a detector configured to detect the radiation reflected from the substrate on a plurality of pixels; and
a data handling unit configured to exclude the pixels having an overlay error larger than a threshold value and average the overlay error of the pixels not excluded to determine the average overlay error.
